(19) United States
(12) Patent Application Publication
(10) Pub. No.: US 2007/0186173 A1
(43) Pub. Date: Aug. 9, 2007

(54) Instant messenger alerts and organization systems

(75) Inventors: Torsten Both, Tangstedt (DE); Christian Lindholm, Ekenas (FI); Bernd Scheibe, Hamburg (DE); Torsten Schulz, Pinneberg (DE)

Correspondence Address: MORRISON & FOERSTER LLP, 755 PAGE MILL RD, PALO ALTO, CA, 94304-1018, US

(73) Assignee: Yahoo! Inc., Sunnyvale, CA (US)

(21) Appl. No.: 11/503,049

(22) Filed: Aug. 11, 2006

Related U.S. Application Data
(60) Provisional application No. 60/765,224, filed on Feb. 3, 2006.

(51) Int. Cl. G06F 3/00

(52) U.S. Cl. 715/753; 715/810

(57) ABSTRACT

An exemplary interface apparatus having navigation logic for navigating multiple instant messaging conversations is described. The navigation logic includes display logic for displaying indicia associated with at least two conversations, selection logic for initiating the display of a conversation associated with each of the indicia in response to a selection thereof, wherein the conversation associated with each indicia is displayed in a common window, and navigation logic for navigating between two conversations within the common window. In one example, the indicia are associated with active instant messaging conversations (e.g., in which the user is engaged). Further, the conversations may be displayed mutually exclusively within the common window.

### CROSS-REFERENCE TO RELATED APPLICATION

This application claims benefit of priority to previously filed U.S. provisional patent application Ser. No. 60/765,224 (Attorney docket no. 324213013500), filed Feb. 3, 2006, entitled USER INTERFACE SYSTEMS AND METHODS, and is hereby incorporated by reference as if fully set forth herein.

### BACKGROUND

1. Field

The present inventions relate generally to systems and methods for user interfaces, and in one example to navigation systems including instant messenger services for a device, such as a computer or mobile device.

2. Related Art

A variety of mobile computing devices exist, including, for example, personal digital assistants (PDAs), mobile phones, smart phones, camera phones, pocket personal computers, and the like. Mobile computing devices are performing an ever growing variety of functions, with the trend for mobile computing devices to have increased functionality such that a single mobile device may, for example, provide Internet access via a Web browser, maintain a personal calendar, provide mobile telephony, capture and store digital photographs, play music and video files, and so on. In short, it is generally desired that mobile devices approach or reach the capability and functionality of stand-alone computers (e.g., personal computers).

Generally mobile devices have less capable user input devices (e.g., keyboards, etc.) than stand-alone computers. For example, a mobile device may include a limited alphanumeric keypad, directional buttons, and the like. Further, the display or viewing screen of the mobile device is often of a smaller size to suit the relatively small, compact size of a typical mobile device.

As the number and complexity of applications included with mobile devices increases, the ability for users to navigate content and use various applications and functions may become increasingly difficult, in part, because of the limited user input devices and viewing screens discussed above. Accordingly, it is desired to provide user interface elements and systems that may be used with a mobile device to navigate multiple applications or services (including, for example, instant messenger services), and may further provide improved ease of use of the device.

### SUMMARY OF THE INVENTIONS

According to some examples of the present invention, methods and systems for navigating and accessing information on a device (e.g., a mobile computer device, computer, or the like) are provided.

In one aspect and example provided herein, an interface apparatus having navigation logic for navigating multiple instant messaging conversations is described. The navigation logic includes display logic for displaying indicia associated with at least two conversations, selection logic for initiating the display of a conversation associated with each of the indicia in response to a selection thereof, wherein the conversation associated with each indicia is displayed in a common window, and navigation logic for navigating between two conversations within the common window. In one example, the indicia are associated with active instant messaging conversations (e.g., in which the user is engaged).

Additionally, in some examples, the navigation logic further includes logic for displaying a first conversation and a second conversation mutually exclusively within the common window. Further, the indicia associated with the at least two conversations may be displayed within the common window and, in one example, mutually exclusive of the display of the conversations.

In another aspect and example, user interface logic is provided for alerting a user of an instant messaging request. In one example the logic is operable to display an indicia (e.g., icon or sound) associated with an instant messaging conversation request in response to an instant messaging communication. The display of the indicia may be in response to receiving an instant messaging communication, e.g., a request for an instant messaging conversation or an actually communication via an instant messaging service. The request may include the name of the requestor or simply be a request from which a user will navigate to or open an instant messaging application to view and/or engage in an instant messaging session. Further, in one example, the request does not include any portion of the instant messaging communication (e.g., it does not include the text of the attempted communication).

In another aspect, a method for navigating multiple instant message conversations on a user device is provided. In one example, the method includes displaying a list of instant messaging conversations, displaying an instant messaging conversation associated with each of the at least two instant message conversations within a common conversations window, and selectively engaging in the at least two instant messaging conversations, wherein the at least two conversations are displayed mutually exclusively within the common conversations window.

According to another aspect, a computer program product comprising program code for navigating multiple instant messaging conversations is provided. The computer program product may include program code operable for displaying a list of instant messaging conversations, and displaying an instant messaging conversation associated with each instant messaging conversation in response to a selection thereof, wherein each instant messaging conversation is displayed within a common window. The instant messaging conversations may be displayed mutually exclusively within the common window.

The various aspects and examples of the inventions are better understood upon consideration of the detailed description below in conjunction with the accompanying drawings and claims.

### BRIEF DESCRIPTION OF THE DRAWINGS

FIG. 1 illustrates an exemplary environment in which exemplary devices, systems, and methods described may be used.

FIGS. 2A-2D illustrate an exemplary user interface, and operation thereof, for navigating and accessing content on a device.

FIG. 3 illustrates an exemplary operation of a user interface for navigating and accessing content on a device.

FIGS. 4A-4C illustrate exemplary user interface elements for navigating content.

FIG. 5 illustrates an exemplary method for navigating content on a device.

FIGS. 6A and 6B illustrate an exemplary user interface including a system and method for alerting a user of one or more instant messaging requests.

FIGS. 7A-7C illustrate an exemplary user interface for navigating and accessing content associated with an instant messaging service on a device.

FIG. 8 illustrates an exemplary method for selecting from and navigating multiple instant messaging sessions on a device.

### DETAILED DESCRIPTION OF THE INVENTIONS

The following description is presented to enable a person of ordinary skill in the art to make and use the inventions. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

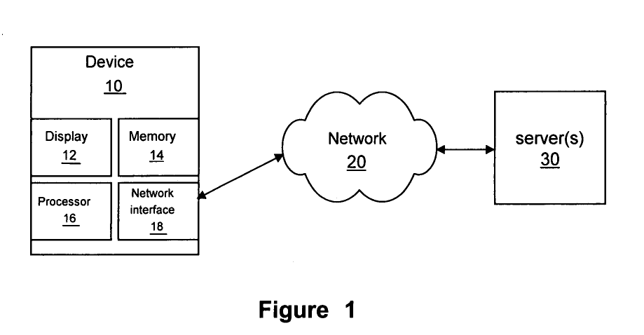

FIG. 1 illustrates an overview of an exemplary environment in which some examples and aspects of a device and content navigation interface described herein may operate and be used. Broadly speaking, a device 10 (including, for example, a mobile computer device) communicates through a network 20 to at least one server 30, which may include account servers (e.g., email servers), mobile servers, and the like. It is noted that an account server, accessible by a user from device 10, may include one or more of a personal email account on an email server (e.g., Yahoo!® Mail), a family photo album account on a photo server (e.g., Yahoo!® Photos), a Personal Information Management (PIM) account on a PIM server (e.g., Yahoo!® Address book or Yahoo!® Notepad), a music library account on a multimedia library server (e.g., Yahoo!® Music), combinations thereof, and the like.

Device 10 may include various hardware, firmware, and/or software, and in particular, a processor 16 connected to an input device such as a keyboard, a network interface 18, a memory 14, and a display 12. Memory 14 (or other portions of device 10) may include logic or software operable with the device to display a content navigation interface and perform some or all of the functions described herein. Device 10 may be operable to include a suitable interface for a messaging facility, such as an email inbox, instant messaging (IM), short messaging service (SMS), multimedia messaging service (MMS), and the like. Device 10 may further be operable to display a web browser for accessing the Internet or user accounts, including webmail environments such as a Yahoo!® mail account or Hotmail® account, for example.

Device 10 may include, for example, a mobile phone, smart phone, Symbian® phone, pocket computer, digital camera, laptop, or handheld personal computer. Device 10 may further include a PIM device such as a Blackberry® or a Treo®, or more dedicated mobile phones that provide more limited information management services. Information management services may include, for example, PIM services such as calendar, address book, tasks, notes, and the like as are generally known.

Device 10 may communicate with one or more servers such as server 30 via network 20, which may include a wireless network, such as a wireless gateway, e.g., a cellular, satellite, or other wireless network. Additionally, device 10 may communicate via a non-wireless network such as a cable or fiber optic network, or a combination of wireless and non-wireless systems.

Network 20 generally includes suitable circuitry for connecting server 30 to network 20, and may be constructed for use with various communication protocols including, but not limited to, TCP/IP, UDP/IP, SMS, IM, and WAP. Network 20 may include or interface with circuitry and components for communicating information, such as email messages, media objects, graphical displays, advertiser data, and the like, over a wired and/or wireless communications medium. Further, network 20 may include or be associated with an SMS center and/or MMS center for transferring files.

Additionally, in one example, a router (not shown) is associated with network 20 and/or one or more servers, e.g., server 30, the router for processing and delivering content between device 10 and server 30. For example, a router may filter data and data structures, parse out data segments, import data, add item IDs to data segments. Additionally, the router may store segments not initially sent to device 10 in a repository (e.g., memory) for later delivery to device 10 and/or delivery to additional content nodes (e.g., other data sinks or data sources). An exemplary router is described, for example, in U.S. patent application Ser. No. 11/264,435, filed Oct. 28, 2005, and entitled “Content Router Core Variants,” the entire content of which is incorporated herein by reference.

Server 30 may include logic or be programmed to format data, accessed from local or remote databases or other sources of data, for presentation to users of device 10, preferably in the format discussed in detail below. Server 30 may include a single device or plural devices, one or more backends, and the like, communicating (wired and/or wireless) and cooperating to perform some or all of the functions described herein. Server 30 may utilize various Web data interface techniques such as Common Gateway Interface (CGI) protocol and associated applications (or “scripts”), Java® “servlets”, i.e., Java applications running on the Web server, or the like to present information and receive input from device 10.

It will be understood by those of ordinary skill in the art that not all the components described may be required, and variations in the arrangement and type of the components may be made without departing from the spirit and scope of the inventions.

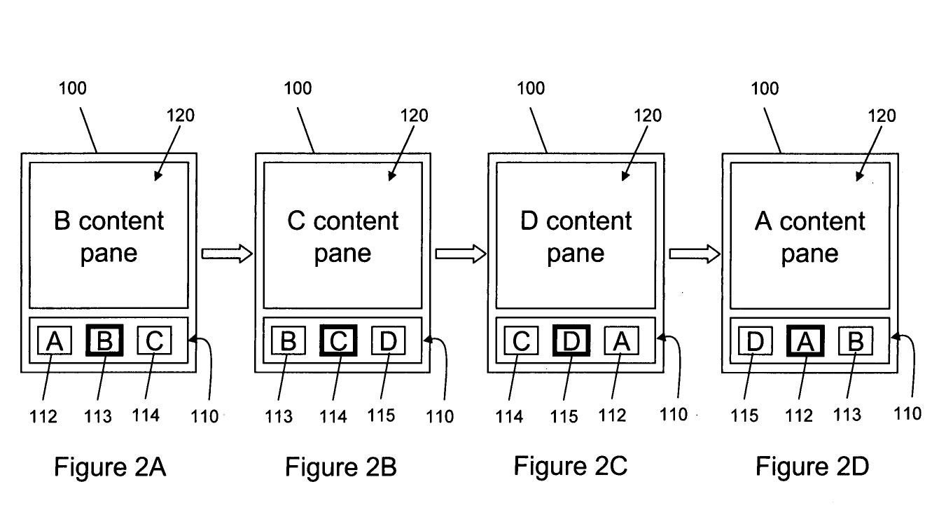

FIGS. 2A-2D illustrate an exemplary user interface 100 for navigating and accessing information on a device. In particular, FIG. 2A illustrates user interface 100 including a content navigation interface element, referred to herein generally as icon carousel 110. Icon carousel 110 is operable to navigate and access content such as applications, services, and content on or accessible by an associated device. User interface 100 and the associated device include or access logic operable to display icon carousel 110, a plurality of icons 112-115, and content associated with the icons, e.g., the services, application, and/or content associated with each icon. Additionally, the user interface 100 and associated device include selection logic for moving the icons 112-115 of icon carousel 110 through a selection position, shown here centered within icon carousel 110, and displaying the associated content when the icon is positioned in the selection position.

In this example, icon carousel 110 includes four icons 112-115, where three of the icons are shown at any given time. Icon carousel 110 is operable to allow a user to “rotate” or move through icons 112-115 as shown by FIGS. 2A-2D. The displayed icons are arranged linearly and are virtually “rotated” in response to user input such that icons move together, e.g., to the left with the leftmost icon being removed and a new icon being added on the right of icon carousel 110. The new icon may include an icon that was not previously displayed, or the icon that was removed from the left. In this fashion, icons 112-115 may appear to a user to be rotating in-and-out of interface 110 and through the selection position.

A user may rotate or move icons 112, 113, and 114 of icon carousel 110, e.g., by using an arrow key or other feature of an input device associated with a particular user device, thereby adding icon 115 to the display of icon carousel 110 and removing icon 113 from the display of icon carousel 110 (as seen in FIG. 2B). Further, the action moves icon 114 to the selection position (e.g., centered within icon carousel 110) and moves icon 113 from the selection position. In this example, the icon positioned at the selection position is highlighted, and remains in one location within icon carousel 110 and interface 100; in particular, centered within icon carousel 110. The icons 112-115 may move within icon carousel 110 in a smooth fashion, e.g., sliding from one position to the next, or may jump from one position to the next. Additionally, a user may rotate icon carousel 110 back to the original icon 113 and may rotate icon carousel 110 in a reverse direction.

Icons 112-115 may be associated with various services and application such as a web browser, email, instant messenger service, photos (e.g., Yahoo!® Photos), weather, news, search, local, sports, finance, entertainment, PIM applications, and the like. As icon carousel 110 is rotated, icons 112-115 are moved through the selection position at the center of icon carousel 110. The user interface 100 includes logic for displaying associated content, in this example, a content pane, in display region 120 for each icon 112-115 such that when successive icons 112-115 are in the selection position, user interface 100 displays a content pane within display 120 associated with that particular icon. The content pane may include a preview of the content associated with a selection of that particular highlighted icon.

As a user rotates icon carousel 110 to highlight one of icons 112-115, it should be understood that icons 112-115 may be highlighted in various fashions, e.g., bolded, enlarged, colored more vividly, different background or border, centered, or the like. Generally, icon carousel 110 or a feature of interface 100 may include an identifiable indicia that a particular icon is in a selection position and may be selected without further rotation of icon carousel 110. In another example, the icon is not highlighted, but it will be apparent that the icon is in a selection position because of the presence of its associated content pane being displayed.

The icons described herein may include any user-identifiable image displayed within the content navigation interface, in this example, within icon carousel 110. Further, the icons may be user configurable or configured by the device/application. For example, a device may be initially populated with default icons, such as an icon for mail, instant messenger, web browser, and the like. In other examples, a user may add or configure icons (e.g., by downloading from a server or uploading from another device). For example, a user may add an icon associated with a particular website, application, etc. Additionally, the icon appearance may be changed or altered by the user, e.g., to include a photo image, emoticon, text, and the like.

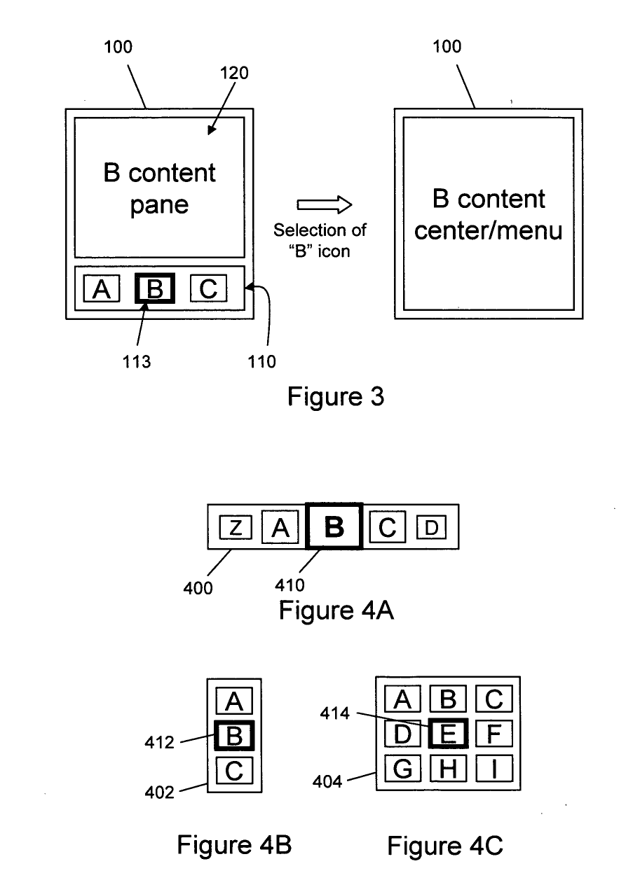

A user may access content associated with the icon in the selection position (and highlighted, for example) of the icon carousel 110 by selecting the icon, e.g., pressing a key, scrolling up, or otherwise indicating a selection (e.g., clicking on the particular icon). Additional content and/or functionality may then be available to the user when selected as shown in FIG. 3. For example, content 130 or a menu of content or options may be displayed when icon 113 is selected. In one example, the icon carousel 110 remains visible to the user as content 130 is displayed. In other examples, the icon carousel 110 may be hidden when icon 113 is selected and content 130 displayed, and the icon carousel 110 may be viewed again, e.g., by an appropriate input via a keypad, “back” function, or the like.

In these examples, icon carousel 110 is illustrated as a horizontal feature at the bottom of user interface 100 having a linear arrangement of icons. A similar icon carousel 110 could be positioned differently, e.g., at the top of the interface 100, be oriented as a vertical feature, or the like.

FIGS. 4A-4B illustrate exemplary content navigation interface elements according to other examples. In particular, FIG. 4A illustrates an exemplary icon carousel 400 illustrating five icons “A” through “D” and “Z” arranged linearly, where the icon in the selection position 410 (in this example, centered within carousel 400) is displayed larger in size than non-selected icons. Additionally, more distant icons from the selection positions are displayed progressively smaller. Icon carousel 400 also indicates that more than 5 icons are accessible through icon carousel 400; in particular, a user may rotate icon carousel 400 to navigate and view successive icons “A” through “Z.” It is too be further understood that each icon “A” through “Z” includes a content pane or other content associated therewith that may be displayed when in the selection position and/or selected by a user.

FIG. 4B illustrates an exemplary icon carousel 402 in which icon carousel 402 is oriented vertically. Icon carousel 402 may operate similarly to icon carousel 110 or 400, but with icons capable of moving or rotating up-and-down (as opposed to left-and-right) through a selection position, shown here centered at 412. The icon carousels 400 and 402 shown in FIGS. 4A and 4B may be placed in various locations within a display as described.

FIG. 4C illustrates an exemplary icon carousel 404 which may be moved or rotated both vertically and horizontally, with icons dropping off and being added based on the direction of movement. The selection position 414 is indicated as being in the center of icon carousel, however, in other examples, the selection position 414 could be located in a different location, e.g., a corner, centered in the top row, etc. Thus, various other modifications and variations to the examples described herein will be apparent.

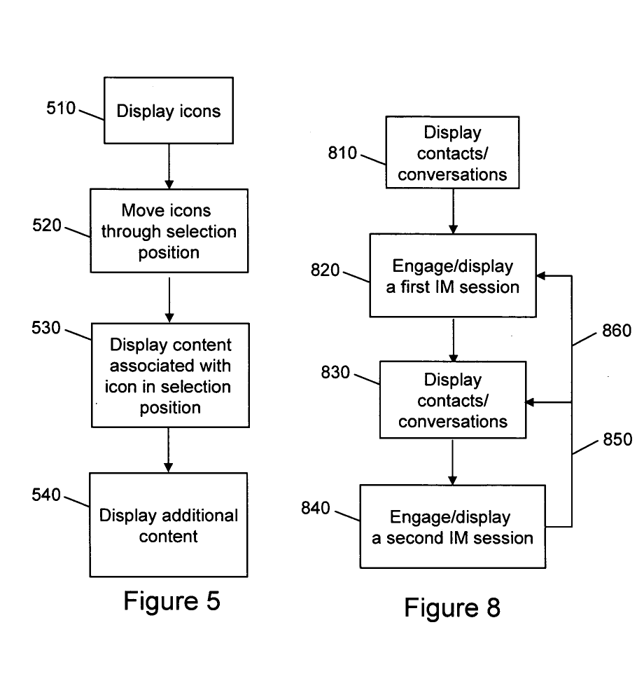

FIG. 5 illustrates an exemplary method for navigating content on or accessible by a user device. A plurality of icons are displayed to a user at 510 with a user interface or user interface element. For example, the icons are displayed within a graphical user interface of a device such as a mobile computer device. The icons may be displayed based on logic included with the device or accessed via a network and server system.

The interface is further operable to move the displayed icons at 520 in response to user input. For example, the icons may be arranged linearly (e.g., horizontally and/or vertically), and movable through a selection position. When icons are moved some of the icons may be removed from the display and additional icons displayed in their place. Further, content associated with an icon positioned at a selection position of the interface is displayed at 530. The content may include, for example, a portion of the content, a preview of the content, or a description of the content. The content my be displayed in a common window, display, etc., or different windows, displays, etc.

In response to a user selecting an icon located at the selection position, additional content is displayed at 540. The additional content may be displayed within the user interface, whether in the same or a different window or panel of the user interface. In other examples, an action or function may take place upon selection, e.g., accessing the phone or voicemail functions of the device.

According to another aspect and example, an apparatus is provided having logic for displaying a request or alert, e.g., an audio and/or graphical indicia, for indicating to a user of a device that an instant messaging request or session has been initiated. For example, a display element may alert a user that an instant messaging session has been requested or is being initiated by another user, wherein the display element does not include information related to the actual session (e.g., it does not include text of the instant messaging session or open an instant messaging window).

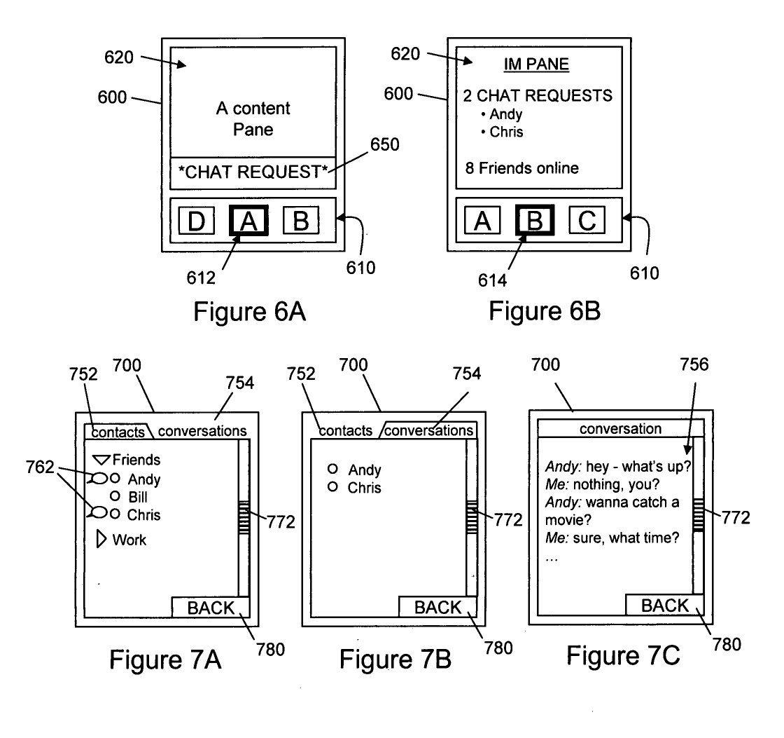

FIGS. 6A and 6B illustrate an exemplary user interface 600, and in particular, a chat request 650 displayed within interface 600. Chat request 650 generally indicates to a user of an associated device that an instant messaging session is or has been requested. Interface 600 and logic for generating chat request 650 may communicate with, be used in conjunction with, or be part of an instant messaging application associated with a device.

In one example, chat request 650 includes an icon, text, or the like that is displayed within user interface 600 in response to receiving an instant messaging communication or an attempt to initiate/begin an instant messaging session with the user or device associated with interface 600. Chat request 650 may display, e.g., the text “chat request,” as shown in FIG. 6A or otherwise display a visual indication that another user or entity wishes to initiate an instant messaging session with the user. Additionally or alternatively, an audio sound or vibration indicating a chat request may be activated on the associated device.

In this example, no portion of the instant messaging session is displayed and the content within content pane 620 does not necessarily correspond to an instant messaging application or display. For example, the chat request 650 may be displayed with or adjacent to a content page or window associated with another application on the device, such as a PIM application, photos, email, or the like. Chat request 650 may be displayed within other application windows or as a separate window overlaying or adjacent another display or content pane.

In this example, a user may navigate to the instant messaging icon, e.g., icon 614, and associated instant messaging content pane 620, which indicates the number of chat requests (if any) and/or the status of the user's contacts (e.g., “friends”). Further, as shown in this example, an icon and/or the name of the requestor may be displayed. Thus, a user may navigate to the instant messaging content pane 620 in response to a chat request 650, for example, and view one or more instant messaging sessions requested (and the identity of the requestor). From instant messaging content pane 620 the user may select the request or otherwise accept the request for an instant messaging session as is known in the art.

According to another aspect and example, an apparatus is provided having logic for displaying and managing multiple conversations (e.g., instant messaging conversations including text, audio, video, or combinations thereof). In one example, the logic is operable to display a screen or window which lists multiple instant messaging conversations and the status of the conversations (e.g., displays icons or other indicia associated with instant messaging conversations). The list of instant messaging conversation may include the conversation status, e.g., active, inactive, or the like. The logic may further be operable to allow the user to select and interact with two or more conversations from the list of instant messaging conversations.

In one example, a user interface associated with a device includes logic operable to display an instant messaging service window or content pane display as illustrated generally in FIGS. 7A-7C. In this example, a user interface 700 displays content of an instant messaging service accessible via two tabs, tab 752 and tab 754 as shown in FIGS. 7A and 7B. The contacts tab 752 (shown displayed in FIG. 7A) displays various contacts, including the identities, the contact's status (e.g., online, offline, busy etc.), and the like. Contacts may further be arranged and displayed in one or more drop-down menus as is generally known in the art (e.g., expandable elements categorized as “friends”, “work,” and so on). In one example, icons 762 may be displayed adjacent a contact identity to indicate an active and/or available conversation.

Conversations tab 754, when selected as shown in FIG. 7B, displays a listing of current conversations of which the user is engaged (or alternatively may be engaged based on the contact status or a request to initiate an instant messaging session). Thus, conversations tab 754 operates to display one or multiple instant messaging sessions available or in progress and selectable by a user.

A user may select one of the instant messaging conversations displayed in tab 754 (e.g., via arrow keys or other input means) and display an instant messaging session window 756 as shown in FIG. 7C. The user may select a back icon 780 (or otherwise indicate a “back” function associated with user interface 700 or the device) to return to the display of tab 754 to select another instant messaging session from the list of instant messaging sessions in the conversations page. In this manner, a user may navigate and switch between multiple instant messaging conversations available under the conversations tab 754 within user interface 700 by selecting particular conversations and jumping back. Further, interface 700 may include logic to store the conversation text such that as a user moves between conversations the previous text of the conversation is displayed.

For example, a user may type a message to a first contact (e.g., “Andy”) within conversations page 756. The user may navigate back to conversations tab 754 and select another contact (e.g., “Chris”) and engage in a second instant messaging session in conversations page 756, where the first and second instant messaging conversation are displayed in the common window. In this example, the first and second conversations are displayed mutually exclusively within the common window.

Further, as a user navigates from a first conversation to a second conversation, the first conversation is stored and recalled if the user navigates back to the first conversation. For example, the previous conversation (e.g., the text of the conversation) is saved and the conversation window may be reopened to continue the conversation. A user may thereby navigate back and forth between two or more conversations within the display.

Additionally, a user may return to contacts tab 752 from conversation page 756 by selecting back icon 780 (or otherwise indicating a “back” function) twice to return first to conversations tab 754 and then to contacts tab 752. In other examples, interface 700 or the device may include a function or input for returning directly to contacts 752. In this manner, a user may navigate between multiple instant messaging session and initiate new instant messaging session (or add other contacts to existing instant messaging sessions). User interface 700 thereby provides the means to navigate and engage in multiple instant messaging session concurrently.

In other examples, the displayed list of available or in progress instant messaging sessions (such as those shown in conversations tab 754) may be displayed concurrently with an opened instant messaging conversation window (such as window 756). For example, instant messaging session window 756 may be tiled or otherwise displayed simultaneously with at least a portion of tab 754 (and/or tab 752), thereby allowing a user to easily navigate multiple instant messaging sessions.

Exemplary user interface 700 may be used in conjunction with the user interfaces and content navigation systems described above, e.g., with respect to FIGS. 2A-2D and 6A-6B. Of course, in other examples, user interface 700 may be used separate from aspects and examples described above, e.g., with different interfaces and content organizations.

FIG. 8 illustrates an exemplary method for selecting from and navigating multiple instant messaging sessions on a device. The method includes displaying contacts or conversations available for an instant messaging conversation at 810. For example, active conversations may be displayed, contacts who are available for a conversation may be displayed, all contacts may be displayed (regardless of status), or combinations thereof.

An instant messaging conversation or session is displayed at 820 in response to a selection of at least one of the contacts or conversations displayed at 810. For example, logic may display a conversation window or page corresponding to the conversation in response to user input indicative of a selection of one or more of the contacts or conversations displayed.

The method further includes displaying the list of contacts or conversations at 830. The list at 830 may be displayed, e.g., in response to a user terminating a displayed conversation window or page or a user wishing to engage or open a second instant messaging session. Further, in this example, a user may display the list of contacts or conversations at 830 without terminating the first instant messaging session, thereby allowing a user to return to the available instant messaging conversations and initiate or engage in a second instant messaging conversation at 840. Thereafter, a user may return to the display of contacts and conversations to return to the first or second instant messaging session as indicated by arrow portions 850 and 860.

In one example, the display of the first and second conversations and the list of contacts are displayed in a common window, and further are displayed mutually exclusively within the common window.

It will be understood that any number of conversations and instant messaging sessions may be accessed and navigated by a user. Further, the display of contacts or conversations at 810 and 830 may be identical or different (e.g., if the status of the contacts changes or conversations are initiated/terminated).

The various aspects and examples of the inventions can be implemented in any suitable form including hardware, software, firmware or any combination of these. Different aspects of the invention may be implemented at least partly as computer software or firmware running on one or more data processors and/or digital signal processors. The elements and components of an embodiment of the invention may be physically, functionally, and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the claims. Additionally, although a feature may appear to be described in connection with a particular embodiment, one skilled in the art would recognize that various features of the described embodiments may be combined in accordance with the invention. Moreover, aspects of the invention describe in connection with an embodiment may stand alone as an invention.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. Instant messaging navigation logic for navigating multiple instant messaging conversations within a user interface, the logic comprising:
display logic for displaying indicia associated with at least two conversations;
selection logic for initiating the display of a conversation associated with each of the indicia in response to a selection thereof, wherein the conversation associated with each indicia is displayed in a common window; and
navigation logic for navigating between two conversations within the common window.

2. The navigation logic of claim 1, wherein the at least two conversations are active instant messaging conversations.

3. The navigation logic of claim 1, further comprising logic for displaying a first conversation and a second conversation mutually exclusively within the common window.

4. The navigation logic of claim 3, wherein the navigation logic comprises logic for displaying the first conversation and the second conversation in response to user input.

5. The navigation logic of claim 1, wherein navigating further includes displaying the indicia associated with the at least two conversations within the common window.

6. The navigation logic of claim 5, wherein the display of indicia is mutually exclusive of the display of the conversation.

7. The navigation logic of claim 1, further including request logic for generating a request for an instant messaging session.

8. The navigation logic of claim 7, wherein the request does not include content of an instant message communication.

9. User interface logic comprising:
logic operable to display an indicia associated with an instant messaging conversation request in response to an instant messaging communication.

10. The user interface logic of claim 9, wherein the display of the indicia is in response to receiving an instant messaging communication.

11. The user interface logic of claim 9, wherein the instant messaging conversation request comprises an icon.

12. The user interface logic of claim 9, wherein the instant messaging conversation request comprises the name of the requester.

13. The user interface logic of claim 9, wherein the instant messaging conversation request does not include content of the instant messaging communication.

14. A method for navigating multiple instant message conversations on a user device, the method comprising:
displaying a list of instant messaging conversations;
displaying an instant messaging conversation associated with each of the displayed instant messaging conversations within a common conversations window; and
selectively engaging in the at least two instant messaging conversations, wherein the at least two conversations are displayed mutually exclusively within the common conversations window.

15. The method of claim 14, wherein the at least two conversations are active instant messaging conversations.

16. The method of claim 14, further comprising displaying the list of at least two conversations within the common window.

17. The method of claim 16, wherein the display of indicia is mutually exclusive of the display of the conversation.

18. The method of claim 14, further comprising generating a request for an instant messaging session.

19. The navigation logic of claim 18, wherein the request does not include content of an instant message communication.

20. A computer program product comprising program code for navigating multiple instant messaging conversations, the computer program product comprising program code for:
displaying a list of instant messaging conversations; and
displaying an instant messaging conversation associated with each instant messaging conversation in response to a selection thereof, wherein each instant messaging conversation is displayed within a common window.

21. The computer program product code of claim 20, wherein the list of instant messaging conversations are active instant messaging conversations.

22. The computer program product code of claim 20, further comprising program code for displaying a first conversation and a second conversation mutually exclusively within the common window.

23. The computer program product code of claim 22, further comprising displaying the first conversation and the second conversation in response to user input.

24. The computer program product code of claim 20, further comprising program code for displaying the list of instant messaging conversations within the common window.

25. The computer program product code of claim 24, wherein the display of list of instant messaging conversations is mutually exclusive of the display of the conversation.

26. The computer program product code of claim 20, further comprising program code for generating a request for an instant messaging conversation.

27. The computer program product code of claim 26, wherein the request does not include content of an instant message communication.
